(19) United States
(12) Patent Application Publication
(10) Pub. No.: US 2004/0122948 A1
(43) Pub. Date: Jun. 24, 2004

(54) Vendor gateway

(76) Inventor: Kevin H. King, Acworth, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/328,480

(22) Filed: Dec. 23, 2002

(51) Int. Cl. G06F 15/173

(52) U.S. Cl. 709/225

(57) ABSTRACT

A network-based system and method limits remote network access to approved network users. A network receives an access request, from a user. Before allowing the user to access network resources, the user receives authentication from a vendor gateway. The vendor gateway determines whether the user is authorized to access the network resources. After the user has supplied information to the vendor gateway, the user is prompted to contact an internal company contact. The internal company contact provides an approved network user with an access code to access the resources of the company network.

### BACKGROUND OF THE INVENTION

A. Field of the Invention

The present invention relates to methods and systems—based in a computer network—for restricting access to the computer network.

B. Description of the Prior Art

In parallel with the growth of the Internet has been the growth in number and sophistication of individuals using the Internet to impermissibly access and exploit computer resources (i.e., computer hackers). Recent studies indicate that in 2001 85% of large corporations and government agencies detected Internet-related security breaches and 64% of corporations and government agencies acknowledged financial losses due to such breaches.

Restricting access to computer resources is difficult because many entities such as businesses, schools, and universities strive to allow easy, remote access to authorized users of their computer resources. Typically, such remote access allows an authorized user to connect to an entity's computer resources through use of a modem or LAN (local area network) connection. Administrators of such remotely accessible networks restrict access by attempting to control who is given the dial-in access numbers, passwords or other information that allows access to the computer resources. If an individual has the necessary password or other information, it is presumed that the individual is an authorized user. Thus, this kind of remote access does not allow for any direct control, inspection, or interrogation of the individual user, as could be provided if the individual was attempting access from on-site.

Hosts and their network administrators quickly recognized that their computer resources needed guarding and that access restrictions to their computer resources needed to be put into place to prevent the proliferation of impermissible access. One solution to this problem is commonly referred to as a “firewall”.

Firewalls are intended to, among other things, shield data and computer resources from the potential ravages of computer network intruders. In essence, a firewall functions as a mechanism that monitors and controls the flow of data between two networks. All communications that flow between the networks in either direction must pass through the firewall. The firewall selectively permits communications to pass from one network to the other according to predetermined criteria such as security criteria, in order to provide bidirectional security.

Another system for improving network security is a code system commonly referred to as a “personal identification number” (“PIN”) system. In a PIN system, a computer maintains a database that includes entries of alphanumeric PINs corresponding to authorized users of the guarded computer resources. To remotely access a computer resource within a network implementing a PIN system, a user connects to the network and is queried for a PIN. If the user submits a PIN, the PIN is received by the network and if the PIN matches an entry in the authorized PIN database, then the user is provided with access to the network and its computer resources. If the PIN does not match, then the attempted connection is not allowed.

Another security system is the caller-identification (Caller-id) system. In this system, a user calls a called party number (CdPN) associated with the host. The calling party number (CgPN) from which the communication originated is identified by the host or the host's network administrator. This CgPN is then compared to CgPNs of authorized users contained in a database. If the CgPN matches an entry in the database of authorized users, then the user is provided with access to the network and its computer resources. If the CgPN does not match, then the attempted communication is not allowed.

Yet another type of security system is known as a “call-back” or “response” system. In a call-back-system, a user calls a CdPN associated with a network or a computer and the network or computer collects certain information about the user. A piece of information that may be collected is the CgPN. After collecting the information, the call-back system terminates the communication. The call-back system compares the collected information from the incoming call to database entries. If the collected information corresponds to an entry in the database of authorized users, the call-back system returns the call to the CgPN or another pre-selected number. If the collected information does not correspond, the system does not return the call.

Within the past several years, security-related problems with communication access restriction have been addressed by the development of the ACE/Server system by Security Dynamics Technologies, Inc., Cambridge, Mass. Generally, the ACE/Server system compares non-predictable codes or PINs for the purpose of identification of authorized users. The ACE/Server system is operated in conjunction with a “token” such as that which is available commercially under the trademark SecurID.RTM., also from Security Dynamics Technologies, Inc. A “token” is a device that is usually portable and/or personal. A token stores machine and/or visually readable data that is usually secret.

In the Ace/Server system, the SecurID.RTM. token generates a six digit passcode that changes every sixty seconds to another, randomly selected, nonpredictable six digit passcode. Both the timing of the change in the passcode and the passcode itself are synchronized with the access control module (ACM) of the ACE/Server system so that, for any authorized user, the passcode momentarily reflected on the SecurID.RTM. token is recognized by the ACE/Server, at that corresponding moment, as the correct passcode for that particular authorized user. The ACE/Server also stores authorized PINs and compares received PINs for access authorization.

These security systems do not adequately protect network resources because they rely exclusively on rejecting users who do not have proper authentication information. These systems do not prevent access from an unauthorized user if that unauthorized user has somehow (a) obtained authentication information from an authorized user, or (b) found a way to bypass the authorization process. Furthermore, these systems do not address the problem of blocking unauthorized access by users who were previously authorized and may have retained the passcodes, PINs or other information provide to them when they were authorized users.

Another major flaw that exists with these systems is that they do not prevent the unauthorized re-entry of a once authorized user once a passcode or entry through the firewall has been granted to that once authorized user. All of these security systems serve as a single, external layer of protection for a company's network. These systems attempt to prevent entry from those users who are prohibited from accessing the company's network. However, once a user has obtained the passcode or has been granted entry through the firewall to the company's network, they are free to pass through to other areas of the network, or possibly leave and then re-enter the network.

Accordingly, with respect to telecommunication service systems, there is a need for a system that provides greater security of network resources.

There is an additional need for a system that maximizes a network's resources by preventing unauthorized entry and use.

There is a further need for a system that provides greater security of network resources by requiring a user to supply information to the network and contact a designated individual within the network, in order to obtain approval to access the system.

### SUMMARY OF THE INVENTION

According to an embodiment of the present invention, a system and method are provided for obtaining access to a network and for making network access more secure.

In accordance with one aspect of the invention, as embodied and broadly described herein, the invention comprises a method of securing access to a network through a vendor gateway. The method comprises the steps of: generating a passcode for a first party; receiving a request to access a part of the network; notifying a second party about the request; and granting access to the part of the network.

In accordance with another aspect of the invention, as embodied and broadly described herein, the invention comprises a computer readable medium having programmed instructions for securing a network through a vendor gateway, the computer readable medium has programmed instructions arranged to: generate a passcode for a first party; receive a request to access a part of the network; notify a second party about the request; and grant access to the part of the network.

In accordance with a further aspect of the invention, as embodied and broadly described herein, the invention comprises a system for securing access to a network, the system comprises: a router; vendor gateway; and a plurality of resources.

It is to be understood that both the foregoing general description and the following detailed description are exemplary and explanatory only and are not restrictive of the invention, as claimed.

Additional aspects and advantages of the invention will be set forth in part in the description which follows, and in part will be obvious from the description, or may be learned by practice of the invention. The advantages of the invention will be realized and attained by means of the elements and combinations particularly pointed out in the appended claims.

The accompanying drawings, which are incorporated in and constitute a part of this specification, illustrate an embodiment of the invention and together with the description, serve to explain the principles of the invention.

### BRIEF DESCRIPTION OF THE DRAWINGS

FIG. 1 is a diagram of a general network from the prior art that provides vendor access.

FIG. 2 is a diagram of a vendor gateway system.

FIG. 3 is a flow diagram of the process implemented at the Vendor Gateway.

### DESCRIPTION OF EXEMPLARY EMBODIMENTS

Reference will now be made in detail to exemplary embodiments of the present invention, examples of which are illustrated in the accompanying drawings. Wherever possible, the same reference numbers will be used throughout the drawings to refer to the same or like parts.

Though this invention is not limited in application to remote access to network resources via the Internet, the following detailed description will describe such an exemplary application. More particularly, exemplary embodiments of the present invention will be discussed in the context of a well-known vendor network, for illustrative simplicity.

The vendor gateway system may provide a second layer of security for a network. An attempted network user, such as a vendor, who wishes to enter a network that includes a vendor gateway will be faced with a second barrier to entry in addition to that provided by the previously described systems. The vendor gateway system may be used in conjunction with the previously mentioned security systems. The vendor gateway may also serve as an independent security system. Generally, when a vendor attempts to access resources located on a particular network, the vendor will be required to log in through the vendor gateway system. This system forces a vendor to obtain network access authorization from a network representative with control of network access before the vendor is allowed to enter the network. A network representative having control over network access, such as an internal company contact, can then make a determination as to whether the vendor is authorized to access the network and its resources. This prevents an unauthorized vendor from entering a network even if the vendor has information such as a valid passcode or PIN. An approved network user, such as a vendor that is authorized to access the network will be able to enter the network.

Companies may desire to allow vendors access to their networks for a variety of reasons, such as to allow the performance of maintenance and repairs of a vendor's software, to allow vendors to stay informed of the company's policies, to allow vendors to bid on projects, to allow vendors to install upgrades to software, and allow the vendors to review and possibly even update a billing account. Once the vendor is given a PIN or access through the firewall, the vendor may be free to enter and leave the network at any time. Many times, a company may only want the vendor to access the network one time, or perhaps a limited number of times or over a limited period of time. Once a company has given a vendor certain information for an authorized visit to the network, there may be subsequent unauthorized visits. Neither a firewall nor a PIN system is able to stop this form of unauthorized access by a vendor. The vendor gateway system, however, addresses this shortcoming.

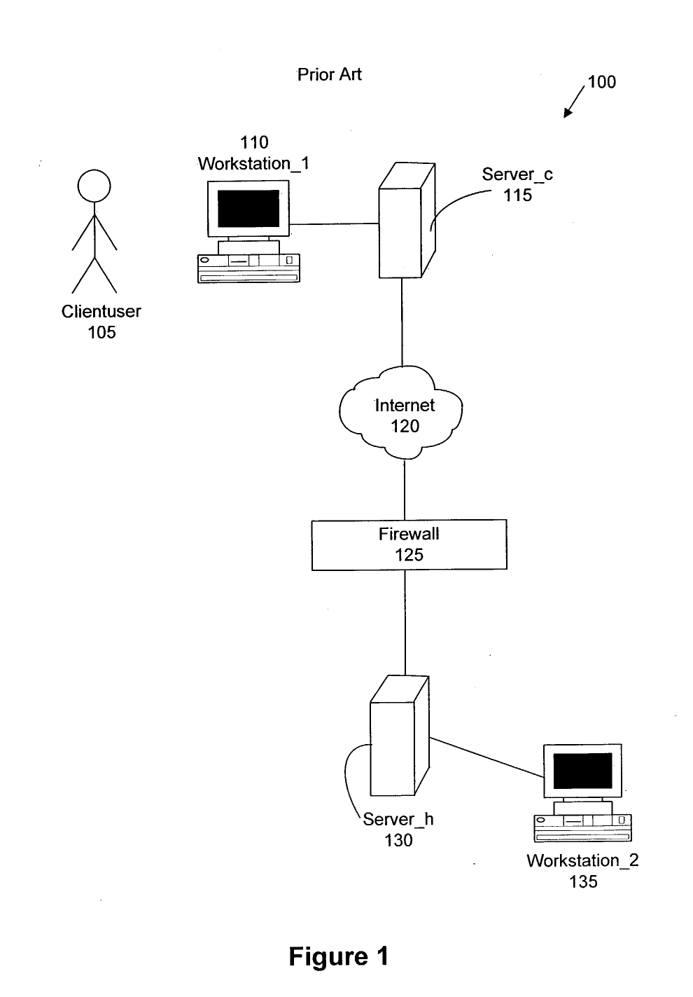

FIG. 1 illustrates a diagram of a general network from the prior art that provides vendor access. This network 100 comprises, for simplicity, a Clientuser 105, a Workstation_1 110, a Server_c 115, the Internet 120, a Firewall 125, a Server_h 130, and a Workstation_2 135.

The central aspect of the network depicted in FIG. 1 is the Internet. The Internet 120 is a vast computer network consisting of many smaller networks that span the entire globe. The Internet 120 has grown exponentially, and millions of users—ranging from individuals to corporations—now use permanent and dial-up connections to access the Internet 120 on a daily basis.

Information on the Internet 120 is made available to the public through “servers”. In FIG. 1, examples of such servers are shown as Server_c 115 and Server_h 130. A server distributes information to any computer that requests the files. Such files are typically stored on magnetic storage devices, such as tape drives or fixed disks. The computer making such a request is known as the “client”, who may be an Internet-connected workstation, bulletin board system or home personal computer (PC). In FIG. 1, the client is shown as Workstation_1 110.

The Clientuser 105 uses the Workstation_1 110 to request access to Server_h 130. The request travels from the Workstation_1 110, to the Firewall 125. However, before the Clientuser 105 will be allowed to obtain the data that is located on Server_h 130, the request must pass through a layer of security. In FIG. 1, the Firewall 125 represents a layer of security that is common in many networks. As discussed previously, a Firewall 125 controls traffic in and out of a company's network. Any request sent from the Clientuser 105 must first pass through the Firewall 125 before the computer accessible resources of the company may be accessed. In addition, many companies implement PIN systems or other conventional security measures to restrict access to their networks. As discussed previously, a PIN system requires a Clientuser 105 to enter a PIN, stored in a database communicatively accessible by the Server_h 110, in order to automatically access the network. Once a Clientuser 105 has passed through these security systems, such as the Firewall 125 or the PIN system, they are free to access the information on Server_h 130.

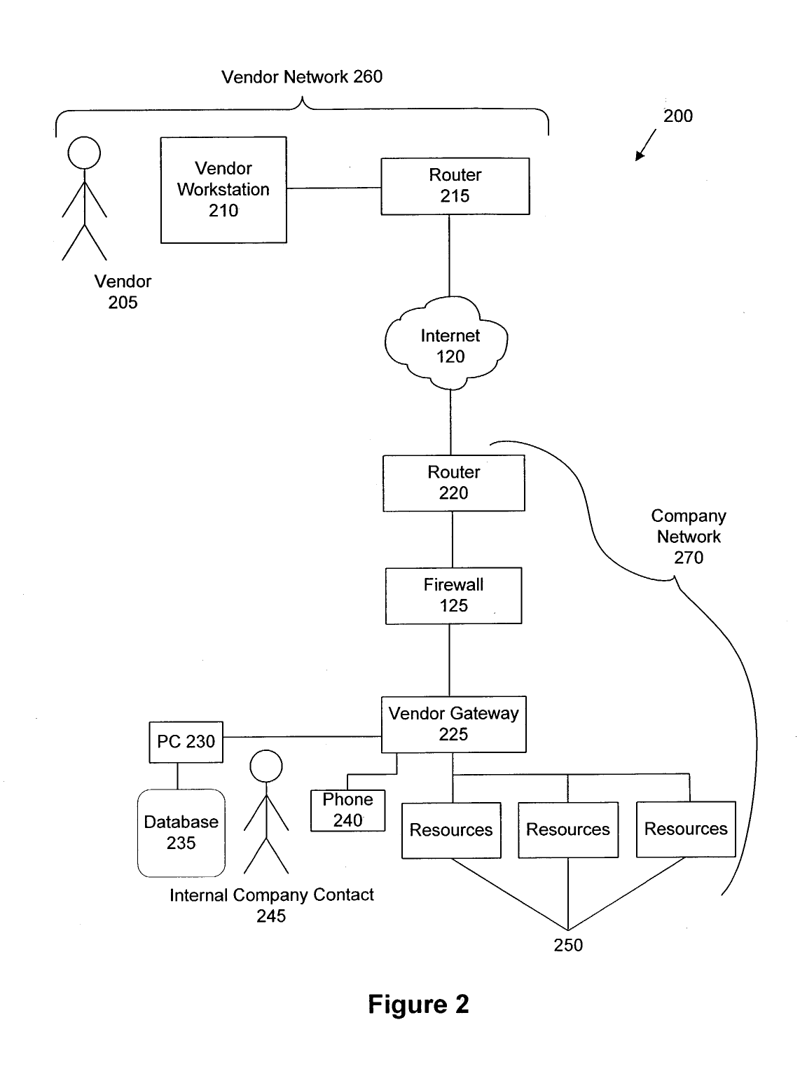

FIG. 2 shows an exemplary configuration of a vendor gateway system 200. The vendor gateway system 200 comprises, generally, a Vendor Network 260 linked to a Company Network 270. The Vendor Network 260 comprises a Vendor Workstation 210 and a Router 215 located at the vendor's site. The Company Network 270 comprises a Firewall 125, a Router 220, and a Vendor Gateway 225. Connected to the Vendor gateway 225 are Resources 250, PC 230, and Phone 240. A Database 235 is connected to the PC 230. A network representative, referred to in the figures as an Internal Company Contact 245, is present at the Company Network 270. The Internet 120 connects the Vendor Network 260 to the Company Network 270 and allows communication between the two. While the present invention is described using a human company contact, the term Internal Company contact includes an automated computer program or artificial intelligence program.

The Vendor 205 accesses the Company Network 270 via the Vendor Workstation 210. The Vendor Workstation 210 may take on many forms, including but not limited to, an Internet-connected workstation, personal computer (PC), laptop, personal digital assistant (PDA) or mobile messaging device. In an exemplary embodiment, the Vendor Workstation 210 is an Internet-connected workstation.

The vendor workstation's request travels to the Router 215 located on the Vendor Network 260. The Router 215 directs the communication to the correct location across the Internet 120 in a well-known manner.

Once the communication has passed through the Internet 120, it arrives at the Router 220 on the Company Network 270. The Router 220 directs the communication to the Firewall 125.

Once the communication containing a request for access to the Company Network 270 has passed through the first layer of security (e.g., the Firewall 125, and possibly the PIN system), the request is directed to the Vendor Gateway 225. The Vendor Gateway 225 temporarily stops the request for access and forces the Vendor 205 to alert the company of its desire to access the portion of the Company Network 270 containing Resources 250. Such Resources 250 may include but are not limited to machines such as servers, disks, files, applications, etc.

In an exemplary embodiment of the present invention, the Vendor Gateway 225 uses a Database 235 to maintain a list of approved vendors and their access codes. Upon receiving a request for access from a Vendor 205 by means such as a PC 230 or Phone 240, the Internal Company Contact 245 accesses the list of approved vendors and access codes from the Database 235. After verifying that the Vendor 205 is authorized to access the Company Network 270, the Internal Company Contact 245 informs the approved Vendor 205 of the access code. The Internal Company Contact 245 may also monitor the Vendor 205 once the Vendor 205 is inside the Company Network 270.

In addition to preventing unauthorized access to a Company Network 270, the vendor gateway system may also be used to prevent the costly waste of time and frustration associated with attempts to access unavailable Resources 250. To accomplish this, the Database 235 may maintain an accounting of the status of the individual Resources 250, including information relating to the operational readiness and current use of applications, the volume and type of data stored, etc. A company may wish to remove certain Resources 250 from the network in order to conduct maintenance, or due to the failure of the Resource 250. A Vendor 205 might be unaware of the availability of a Resource 250 and may-after having been granted access to the Company Network 270—spend time searching for a Resource 250 that is unavailable. In this embodiment of the present invention, the Internal Company Contact 245 could notify the Vendor 205 of possible unavailable Resources 250, saving the Vendor 205 time and further developing goodwill between the Vendor 205 and the company.

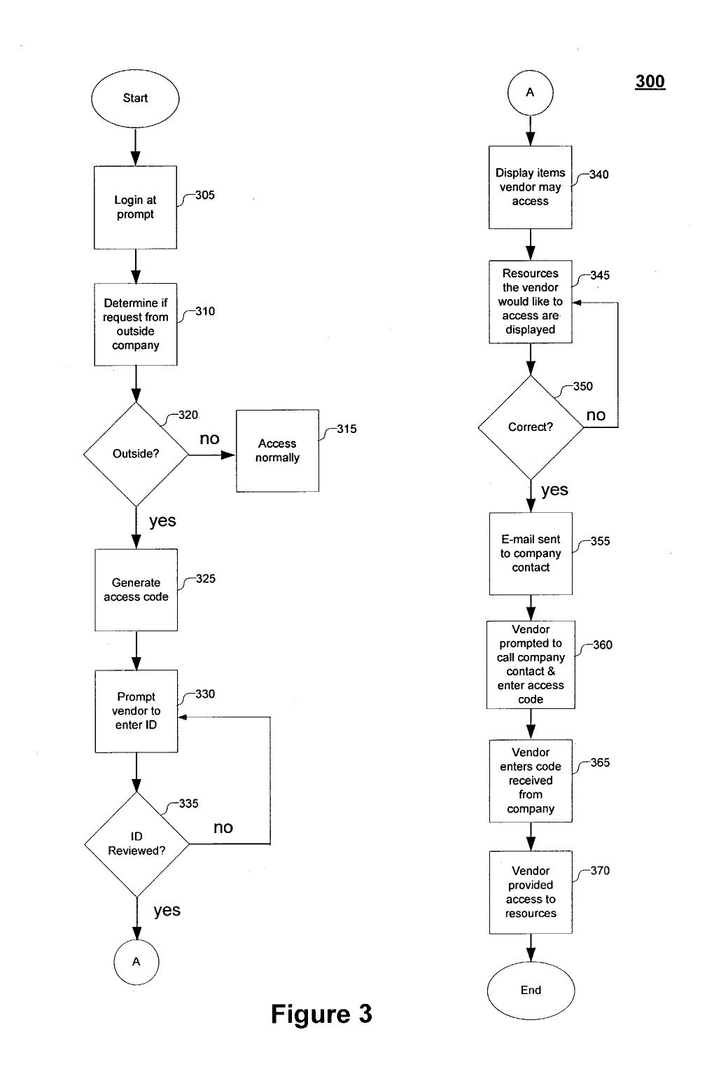

FIG. 3 discloses an exemplary detailed flow diagram of the process implemented at the Vendor Gateway 225.

At stage 305, the Vendor Gateway 225 prompts the Vendor 205 to enter a log in id and a passcode. The Vendor 205 is next prompted to enter identification information. This information allows the Vendor 205 to begin the process of authentication at the Vendor Gateway 225.

At stage 310, the Vendor Gateway 225 determines if the Vendor 205 is accessing the network from inside or outside of the Company Network 270. There are various ways that this information can be obtained. One method is by examining the IP (Internet Protocol) address of the Vendor Workstation 210. All computers on the Internet have a unique ID code, known as the IP address. Based on this unique ID code, the Company Network 270 may determine if the Vendor Workstation 210 is within or outside the Company Network 270.

At decision block 320, a determination is made as to whether the Vendor 205 is attempting to access the Company Network 270 from inside or outside of the company. If it is determined that the Vendor 205 is accessing the network from within the company, the Vendor 205 may bypass the Vendor Gateway 225 and directly access the Resources 250 of the company, as depicted, generally, in stage 315. However, if at stage 320 it is determined that the Vendor 205 is accessing the Company Network 270 from outside the company, the Vendor 205 continues the access process through the Vendor Gateway 225 by an access code being generated by the Vendor Gateway 225, in response to the attempted connection to the Company Network 270, depicted at stage 325. An access code is a randomly generated code that is not displayed to the Vendor 205. The access code is stored in Database 235 and is accessible by the Internal Company Contact 245.

Next, a Vendor 205 who is determined to be outside the Company Network 270 is prompted to enter additional identification information, shown in stage 330. This identification information may include the client call number, client name, client telephone number, client email address, contact name (name of the contact person), contact telephone number and a description of the reason for entering the Company Network 270. At stage 335, this information is then displayed to the Vendor 205, on the Vendor Workstation 210 and the Vendor 205 is allowed to correct any errors.

Next, at stage 340, the Vendor Gateway 225 determines the level of access a Vendor 205 may receive, based on the information input by the Vendor 205 and information corresponding to the Vendor 205 maintained within the Company Network 270. Based on this determination, a list of possible Resources 250 or a plurality of accessible portions of the network the Vendor 205 may access is presented. At stage 345 the Vendor 205 indicates which Resources 250 available for access within the Company Network 270 the Vendor 205 wishes to actually access. At decision block 350, the selections made by the Vendor 205 are displayed and the Vendor 205 is allowed to correct any errors. If the correct selection was made, the Vendor 205 proceeds to the next step. Otherwise, the Vendor 205 changes the selection until it is correct, as depicted.

After the correct selections have been entered by the Vendor 205, the Internal Company Contact 245 may be notified through many methods, including but not limited to email, fax and voice message, as depicted in stage 355. The notification includes the information supplied by the Vendor 205 and the access code. At stage 360, the Vendor 205 is prompted to enter the access code. The prompt also includes the contact information of the Internal Company Contact 245.

At stage 365, the Vendor 205 enters the access code that was received from calling the Internal Company Contact 245 and, at stage 370, the Vendor 205 is provided access to certain of the Resources 250. The method ends at stage 375.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for restricting access to a network, comprising the steps of:
requiring an attempted network user to provide access information;
notifying a network representative of the access information; and
verifying, through the network representative, that the access information corresponds to an approved network user and that the approved network user provided the access information.

2. The method of claim 1, further comprising verifying, through the network representative, that the approved network user provided the access information, allowing the approved network user to access the network.

3. The method of claim 2, wherein allowing the approved network user to access the network comprises providing the approved network user with an access code.

4. The method of claim 3, wherein the access code is generated by the network.

5. The method of claim 4, wherein the network representative is notified of the access code.

6. The method of claim 3, wherein the access code is provided by the network representative to the approved network user.

7. The method of claim 1, further comprising determining whether a network access request originated from within the network, and, if so, permitting the attempted network user to access the network.

8. The method of claim 1, wherein requiring an attempted network user to provide access information comprises displaying a plurality of accessible portions of the network to the attempted network user.

9. The method of claim 8, wherein the attempted network user selects accessible portions of the network.

10. The method of claim 1, wherein access information comprises identification information.

11. The method of claim 10, wherein identification information comprises a name, a client e-mail, a client telephone number, a client call number, a contact name, a contact e-mail and a contact telephone number.

12. The method of claim 1, wherein notifying a network representative of the access information comprises having e-mail sent to the network representative.

13. The method of claim 1, wherein notifying a network representative of the access information comprises having a fax sent to the network representative.

14. The method of claim 1, wherein notifying a network representative of the access information comprises having a voice message sent to the network representative.

15. The method of claim 5, wherein notifying a network representative of the access code comprises having e-mail sent to the network representative.

16. The method of claim 5, wherein notifying a network representative of the access code comprises having a fax sent to the network representative.

17. The method of claim 5, wherein notifying a network representative of the access code comprises having a voice message sent to the network representative.

18. A computer readable medium having programmed instructions for restricting access to a network, having programmed instructions arranged to:
require an attempted network user to provide access information;
notify a network representative of the access information;
verify, through the network representative, that the access information corresponds to an approved network user; and
responsive to verifying, through the network representative, that the access information corresponds to an approved network user, further verifying that the approved network user provided the access information.

19. A computer readable medium as described in claim 18, comprising programmed instructions for responsive to verifying that the approved network user provided the access information, allowing the approved network user to access the network.

20. A computer readable medium as described in claim 19, comprising programmed instructions for determining whether a network access request originated from within the network, and, if so, permitting the attempted network user to access the network.

21. A computer readable medium as described in claim 20, comprising programmed instructions for generating an access code.

22. A computer readable medium as described in claim 21, comprising programmed instructions for notifying the network representative of the access code.

23. A computer readable medium as described in claim 18, comprising programmed instructions for limiting the accessible portions of the network accessible to the attempted network user.

24. A computer readable medium as described in claim 18, comprising programmed instructions for automatically notifying the network representative of the access information corresponding to an approved network user by sending an e-mail message to the network representative.

25. A computer readable medium as described in claim 18, comprising programmed instructions for automatically notifying a network representative of the access information corresponding to an approved network user sending a fax to the network representative.

26. A computer readable medium as described in claim 18, comprising programmed instructions for automatically notifying a network representative of the access information corresponding to an approved network user by sending a voice message to the network representative.

27. A computer readable medium as described in claim 22, comprising programmed instructions for automatically notifying the network representative of the access code corresponding to an approved network user by sending an e-mail message to the network representative.

28. A computer readable medium as described in claim 22, comprising programmed instructions for automatically notifying a network representative of the access code corresponding to an approved network user sending a fax to the network representative.

29. A computer readable medium as described in claim 22, comprising programmed instructions for automatically notifying a network representative of the access code corresponding to an approved network user by sending a voice message to the network representative.

30. A system for restricting access to a network, comprising:
a network communicatively interconnected to the Internet;
a vendor gateway for restricting access to the network through the Internet;
whereby the vendor gateway is functional to determine whether a network access request contains access information corresponding to archived access information for approved network users and, if so, the vendor gateway is further functional to require independent verification that an attempted network user submitting the network access request corresponds to an approved network user.

31. The system of claim 30, wherein the independent verification that an attempted network user submitting the network access request corresponds to an approved network user is a voice communication between a network representative and the attempted network user.

32. The system of claim 30, wherein the independent verification that an attempted network user submitting the network access request corresponds to an approved network user is a fax communication between a network representative and the attempted network user.
